(19) United States
(12) Patent Application Publication
(10) Pub. No.: US 2006/0216503 A1
(43) Pub. Date: Sep. 28, 2006

(54) Acrylic adhesive tape system

(75) Inventor: Samuel M. Hambrick JR., Levittown, PA (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Tyco Adhesives LP, Franklin, MA (US)

(21) Appl. No.: 11/089,463

(22) Filed: Mar. 24, 2005

(51) Int. Cl. B32B 7/12

(52) U.S. Cl. 428/354; 428/317.3; 428/317.7; 428/355 AC

(57) ABSTRACT

An adhesive tape system is provided. In one embodiment, the adhesive tape system includes a carrier layer having a first acrylic-based adhesive disposed on a first side and a second acrylic-based adhesive disposed on an opposing second side. A foam layer has a first side bonded to the second side of the carrier layer by the second acrylic-based adhesive and an opposing second side having a third acrylic-based adhesive disposed thereon. The foam layer may further include an open cell urethane foam.

### BACKGROUND OF THE INVENTION

1. Field of the Invention

This invention relates to pressure sensitive adhesive tape products and, more particularly, to a pressure sensitive acrylic adhesive tape system.

2. Description of the Related Art

In one method of transfer printing, a printing plate having an image of the text or design to be printed is mounted to a smooth print drum or cylinder. The print cylinder is supported horizontally in the path of a web of material that is to be printed. The printing plate typically comprises a rubber sheet that has an upper surface formed or cut away to a pattern corresponding to a negative of the image desired to be printed. The print cylinder rotates the printing plate through an inking mechanism, for example, a well containing the medium to be transferred to the web or a transfer drum that places a measured coating of the printing medium onto raised portions of the printing plate, and the like. As the print cylinder continues to rotate, the wetted portions of the printing plate come into contact with the web, typically under pressure, and transfer the printing medium to the web, thus forming the image on the web.

The rubber printing plate is typically wrapped around and secured to the print cylinder by adhesives, such as a double sided pressure sensitive adhesive tape system. In addition, a thin layer of foam is generally interposed between the rubber printing plate and the cylinder to act as a cushion. The foam layer may be part of the adhesive tape system that is adhered to the print cylinder on one side and the rubber printing plate on the other.

It is critical that the rubber printing plate adhere to the tape system and to the printing drum in a smooth, uniform fashion. Any gaps or wrinkles, possibly due to delamination along any of the interfaces between the rubber plate, any of the layers of the adhesive tape system, and/or the printing plate, will cause nonuniformities and defects in the print quality, such as smearing or non-printed areas.

Such defects may be severe enough to require scrapping the end product. In addition, failure of the adhesion of the layers of the adhesive tape system and either the printing cylinder and the printing plate requires interruption in the printing run while the adhesive tape system is removed and replaced. In addition, if the adhesive leaves behind a residue on either the printing plate or the printing drum, or if the foam layer tears and remains behind, additional time is required to clean the surfaces of the printing plate and/or print cylinder to ensure a smooth, flat surface as required for acceptable quality print.

Conventionally, a typical adhesive tape system includes a foam layer and a carrier layer and utilizes a rubber-based adhesive to bond the layers and to couple the rubber printing plate to the print cylinder. However, it has been noticed that the foam layer sometimes delaminates from the carrier layer, resulting in the carrier layer and rubber adhesive remaining stuck to the print cylinder. In addition, the raw materials required to make the rubber-based adhesive are becoming more rare, and more expensive. Furthermore, the rubber-based adhesives are less resistant to solvents typically used in the printing industry, further causing potential for delamination or failure of the adhesive tape system.

Thus, there is a need for an improved adhesive tape system.

### SUMMARY OF THE INVENTION

In one embodiment, an adhesive tape system includes a carrier layer having a first acrylic-based adhesive disposed on a first side and a second acrylic-based adhesive disposed on an opposing second side. A foam layer has a first side bonded to the second side of the carrier layer by the second acrylic-based adhesive and an opposing second side having a third acrylic-based adhesive disposed thereon.

In another embodiment, an adhesive tape system includes a carrier layer having a first acrylic-based adhesive disposed on a first side and a second acrylic-based adhesive disposed on an opposing second side. An open cell urethane foam layer has a first side bonded to the second side of the carrier layer by the second acrylic-based adhesive and an opposing second side having a third acrylic-based adhesive disposed thereon. A paper liner is disposed on the first side of the carrier layer, the paper liner coated on both sides with a polyethylene and silicone coating.

In another embodiment, a printing apparatus includes a printing plate and a print cylinder. An adhesive tape system couples the printing plate to the print cylinder. The adhesive tape system includes a carrier layer having a first acrylic-based adhesive disposed on a first side and a second acrylic-based adhesive disposed on an opposing second side. A foam layer has a first side bonded to the second side of the carrier layer by the second acrylic-based adhesive and an opposing second side having a third acrylic-based adhesive disposed thereon.

### BRIEF DESCRIPTION OF THE DRAWINGS

FIG. 1 is a partial isometric of an adhesive tape system of an embodiment of the present invention;

FIG. 2 is a flowchart depicting an embodiment of a method of making the adhesive tape system of FIG. 1; and

FIG. 3 is a schematic side view of a printing apparatus utilizing the adhesive tape system in accordance with an embodiment of the present invention.

### DETAILED DESCRIPTION

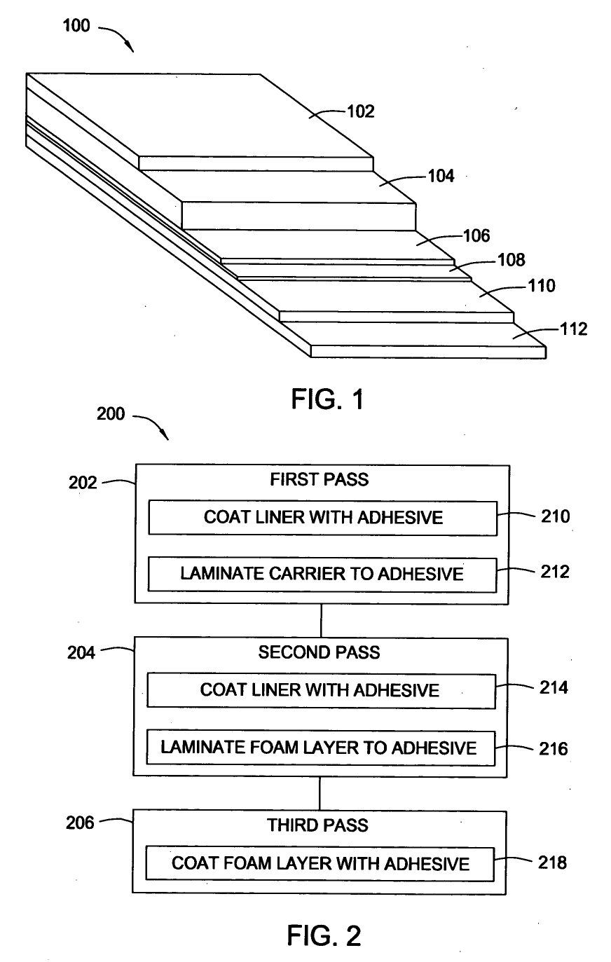

FIG. 1 depicts one embodiment of an adhesive tape system 100 of the present invention. The system 100 generally comprises a foam layer 104 coupled to a carrier 108 by an adhesive layer 106. An adhesive layer 102 is disposed on the foam layer 104 on a side opposite the carrier 108. The carrier 108 further has an adhesive layer 110 and a liner 112 disposed on a side of the carrier layer opposite the foam layer 104.

The carrier 108 typically comprises polyethylene terephthalate (PET). Alternatively, the carrier 108 may comprise polyethylene (PE), polypropylene (PP), polysulfone (UDEL), polyethersulphone (PES), or polyetherimide (ULTEM).

The carrier 108 may be from about 0.5 mils to 2 mils in thickness. In one embodiment, the carrier layer is 0.5 mils thick. In order to increase the bond between the carrier 108 and the adhesive layer 106 and/or the adhesive layer 110, one or both sides of the carrier layer 108 may be treated to increase the surface tension of the carrier layer 108. In one embodiment, both sides of the carrier 108 are corona treated. The corona treatment may be performed on conventional corona treating equipment at a density of 4.0 to 8.5, having kilowatts relative to speed, and at a line speed in the range of from about 30 to about 70 feet per minute. In one embodiment, the carrier 108 may be corona treated at a density level of about 8.5 and at a line speed of between about 30-70 feet per minute.

The foam layer 104 typically comprises a urethane foam, for example, an open cell urethane foam. Alternatively, the foam layer 104 may comprise a polyolefin, vinyl, or polyethylene foam. The foam layer 104 generally ranges in thickness from about 20 mils to about 60 mils. In one embodiment, the foam layer 104 is 60 mils thick. One example of a suitable material for the foam layer 104 is PORON®, available from Rogers Corp., High Performance Elastomers Division, PORON Materials Unit, of East Woodstock, Conn.

The bond between the foam layer 104 and the adhesive layer 102, and/or the adhesive layer 106, may be increased by treating one or more sides of the foam layer 104 to increase the surface tension of the foam layer 104. The corona treatment may be performed on conventional corona treating equipment at a density of 4.0 to 8.5, having kilowatts relative to speed, and at a line speed in the range of from about 30 to about 70 feet per minute. In one embodiment, the foam layer 104 is corona treated on both sides at a density of 8.5 and at a line speed of about 30-70 feet per minute.

The liner 112 may be any suitable liner compatible with the adhesive layer 110 and the adhesive layer 102. In one embodiment, the liner 112 comprises paper having a polyethylene and silicone coating formed on both sides of the liner 112. The polyethylene and silicone coating may be perforated on one side of the liner 112 to allow moisture to escape during an adhesive coating operation, as described more fully below. The weight of the liner 112 may be in the range of from about 60 pounds per ream to about 80 pounds per ream. Alternatively, the liner 112 may comprise a film liner such as bi-oriented polypropylene, high density polyethylene, PET, polystyrene, and the like. The film liner may range in thickness from about 2 mils to about 6 mil thick with a silicone release coating.

The construction of the system 100, and the application and formulation of adhesive layers 102, 106, and 110, may be best understood with reference to the method of construction of the system 100, as depicted in FIG. 2. FIG. 2 depicts one embodiment of a three-pass method for fabricating the system 100. The method 200 utilizes conventional coating and lamination equipment. Although the method 200 describes a three-pass method of fabricating the adhesive tape system 100, it is contemplated that other methods may be used to construct the system 100 including methods using similar or different machinery and having a similar or different order of steps of the construction of the system 100. In addition, steps well-known in the art, such as winding and unwinding the material layers, and the like, are not described in detail below.

The method 200 begins at step 202, where a first pass is made through a conventional coating machine having a heated lamination nip at the exit of the oven. The first pass 202 forms the adhesive layer 110 disposed between the carrier 108 and the liner 112.

The first pass 202 typically includes sub-step 210, wherein the liner 112 is coated with the adhesive layer 110. In one embodiment, the adhesive layer 110 is formed from a first adhesive. The first adhesive is an acrylic pressure sensitive adhesive comprising from about 94.60 to about 94.67 percent by weight of a first acrylic base, from about 2.37 to about 2.40 percent by weight of solvent, from about 2.37 to about 2.40 percent by weight resin, and from about 0.59 to about 0.60 percent by weight cross linker. In one embodiment, the first adhesive is an acrylic pressure sensitive adhesive comprising about 94.641 percent by weight of a first acrylic base, 2.381 percent by base of solvent, 2.381 percent by weight resin, and 0.597 percent by weight cross linker. Acceptable ranges of variation for these and all other compositions provided herein are as follows: amounts greater than 10 pounds may have a plus or minus 1 percent variation, amounts ranging from about 3 to about 10 pounds may also have a plus or minus 1 percent variation, and amounts less than about 3 pounds may have a plus or minus 5 percent variation. All weights use the gram scale, i.e., 1 pound=454 grams.

In one embodiment, the first acrylic base is an acrylic polymer and has between about 38.6 and about 42.6 percent solids. In one embodiment, the first acrylic base has about 40 percent solids. One example of a suitable first acrylic base is, for example, Polytac-284, available from Ashland Specialty Chemical Company of Totowa, N.J. The solvent typically comprises toluene. The resin typically comprises oil-soluble terpene phenolic, and has between about 48 and about 100 percent solids. In one embodiment, the resin has about 100 percent solids. One example of a suitable resin is, for example, SP-553, available from Schenectady Chemicals, Inc, of Schenectady, N.Y. The crosslinker typically comprises toluene diisocyanate, and has between about 40 and about 80 percent solids. In one embodiment, the crosslinker has about 60 percent solids. One example of a suitable crosslinker is, for example, Mondur-CB-601, available from D.H. Litter, of Elmsford, N.Y.

The first adhesive is generally mixed at least 24 hours prior to application to the liner 112. The first adhesive may be mixed by, for example, a drum mixer affixed to the rim of a drum, or container, of the first adhesive. The first adhesive is mixed for a period of time suitable to thoroughly mix the first adhesive, for example, between ¼ and ¾ hours. The first adhesive is applied during sub-step 210 via conventional coating mechanism, for example, using a reverse roll coater, to apply a dry coating weight of from about 21 to about 25 pounds per ream of the first adhesive on the liner 112. In one embodiment, about 23 pounds per ream of the first adhesive is coated onto the liner 112 and is cured to form the adhesive layer 110. In embodiments where the coating on the liner 112 is perforated on one side, the first adhesive is generally applied to the non-perforated side of the liner 112.

The first adhesive is then dried or cured in an oven at suitable speed and temperature to cure the first adhesive and thereby form the adhesive layer 110. In one embodiment, the first adhesive is cured in a five zone oven having a first zone heated between about 120 and about 140 degrees Fahrenheit, a second zone heated to between about 120 and about 150 degrees Fahrenheit, a third zone heated between about 165 and about 185 degrees Fahrenheit, a fourth zone heated to between about 190 and about 210 degrees Fahrenheit, and a fifth zone heated between about 200 and about 215 degrees Fahrenheit. In one embodiment, the first zone is heated to about 130 degrees Fahrenheit, the second zone is heated to about 140 degrees Fahrenheit, the third zone is heated to about 175 degrees Fahrenheit, the fourth zone is heated to about 200 degrees Fahrenheit, and the fifth zone is heated to about 200 degrees Fahrenheit. In one embodiment, each zone of the oven is about 20 feet in length. In one embodiment, the coater line speed ranges between about 30 to about 80 feet per minute. It is contemplated that other line speeds, heating chambers and temperatures may be used to cure the first adhesive, for example, in embodiments having varying adhesive compositions, coating weights, zone lengths, number of zones, and the like.

The first pass 202 also comprises sub-step 212, wherein the carrier 108 is laminated to the adhesive layer 110. The carrier 108 may be laminated to the adhesive layer 110 and the liner 112 utilizing conventional laminating equipment. In one embodiment, the carrier 108 is laminated to the adhesive layer 110 immediately upon completion of curing of the adhesive layer 110 as the liner 112 exits the oven. Alternatively, the adhesive layer 110 and the liner 112 coated in sub-step 210 may be wound up upon exiting the oven and may be laminated to the carrier 108 on a separate laminating machine.

The carrier 108 is laminated to the adhesive layer 110 using suitable process conditions to create a smooth, secure bond between the carrier 108 and the adhesive layer 110. The carrier 108 may generally be laminated to the adhesive layer 110 at full compression with a pressure of between 10 and about 35 pounds per square inch and at a line speed of between about 30 and about 80 feet per minute. In one embodiment, the laminating nip is heated, for example, between a temperature of about 150 and about 200 degrees F. In one embodiment, the laminating nip is heated to a temperature of about 200 degrees Fahrenheit. In one embodiment, both sides of the foam layer 104 is corona treated as described above.

Next, during a second pass 204, the foam layer 104 is adhered to the carrier 108 by the adhesive layer 106. In one embodiment, the second pass 204 comprises sub-step 214, wherein the carrier 108 is coated with a second adhesive that is cured to form the adhesive layer 106. The second adhesive generally comprises an acrylic pressure sensitive adhesive. In one embodiment, the second adhesive comprises 100 percent per weight of a second acrylic base. The second acrylic base comprises, for example, acrylic polymer, and typically has between about 37 to about 55 percent solids. In one embodiment, the second acrylic base has about 45 percent solids. One example of a suitable second acrylic base is, for example, Aroset-PS781, available from Ashland Industries, of Totowa, N.J.

During sub-step 214, the second adhesive is applied by a conventional coater to the carrier 108 on a side opposite the adhesive layer 110 and the liner 112. The adhesive layer 106 may be formed in a similar fashion as the adhesive layer 110, described above. The second adhesive is generally applied to a coating weight of between 29 and 30 pounds per ream. In one embodiment, the second adhesive is applied to a coating weight of about 27 pounds per ream. The second adhesive is then cured in an oven to form the adhesive layer 106. In one embodiment, the second adhesive is cured in a five-zone oven under the same conditions as described above with respect to the adhesive layer 110. It is contemplated that other process conditions may be utilized to form the adhesive layer 106 for similar reasons as described above with respect to the adhesive layer 110.

The second pass 204 also typically comprises a sub-step 216, wherein the foam layer 104 is laminated to the adhesive layer 106. The foam layer 104 may be laminated to the adhesive layer 106, the carrier 108, the adhesive layer 110, and the liner 112 utilizing conventional laminating equipment. In one embodiment, the foam layer is laminated to the adhesive layer 106 immediately upon completion of curing of the adhesive layer 106 as the carrier 108 exits the oven. Alternatively, the adhesive layer 106 and the carrier 108 coated in sub-step 210 may be wound up upon exiting the oven and may be laminated to the foam layer 104 on a separate laminating machine.

The foam layer 104 is laminated to the adhesive layer 106 using suitable process conditions to create a smooth, secure bond between the foam layer 104 and the adhesive layer 106. The foam layer 104 may generally laminated to the adhesive layer 106 utilizing a lamination pressure of between about 10 percent and about 15 percent compression and at a line speed of between about 30 to about 50 feet per second. In one embodiment, the foam layer 104 is laminated to the adhesive layer 106 utilizing a lamination pressure of about 10 percent compression at a line speed of about 40 feet per minute. In one embodiment, the laminating nip is heated, for example, between a temperature of about 150 and about 200 degrees F. In one embodiment, the laminating nip is heated to a temperature of about 200 degrees Fahrenheit. In one embodiment, both sides of the foam layer 104 is corona treated as described above.

Finally, during a third pass 206, an adhesive layer 102 is formed on the foam layer 104. The third pass 206 typically comprises sub-step 218, wherein the foam layer 104 is coated with a third adhesive that is cured to form the adhesive layer 102. The third adhesive typically comprises an acrylic pressure sensitive adhesive. In one embodiment, the third adhesive comprises 100 percent by weight of a third acrylic base. The third acrylic base comprises, for example, acrylic polymer, and typically has between about 40 to about 45 percent solids. Suitable examples of third acrylic bases include Aroset-1450 or Aroset-PS781, both available from Ashland Industries, of Totowa, N.J.

The third adhesive is coated onto the foam layer 104 on the side opposite the liner 112 and is cured to form the adhesive layer 102 in a manner similar to forming the adhesive layers 106, 110. In one embodiment, the adhesive layer is formed at a coat weight between about 25 to about 32 pounds per ream. In one embodiment, the adhesive layer is deposited at a coating weight of between about 27 and about 30 pounds per ream. The third adhesive is then cured in an oven to form the adhesive layer 102. In one embodiment, the third adhesive is cured in a five-zone oven under the same conditions as described above with respect to the adhesive layers 106, 110. It is contemplated that other process conditions may be utilized to form the adhesive layer 102 for similar reasons as described above with respect to the adhesive layers 106, 110.

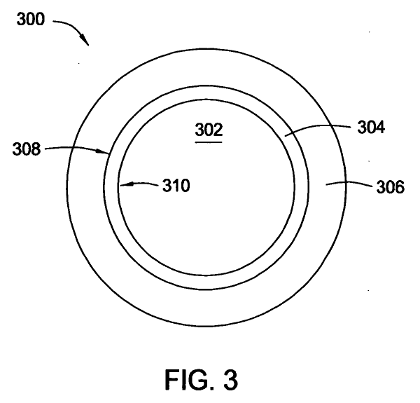

Upon completion of the third pass 206, the adhesive tape system 100 is complete. The completed system 100 may further be converted into intermediate or final smaller sizes suitable for use, for example, in adhering printing plates to print drums. FIG. 3 depicts a simplified schematic side view of one embodiment of a printing apparatus 300 utilizing an adhesive tape system of one embodiment of the present invention. The printing apparatus includes a printing plate 306 coupled to a print cylinder 302 by an adhesive tape system 304. The printing plate 306 is generally a flexible plate that can be wrapped around the print cylinder 302 and secured thereto by the system 304. The printing plate may be, for example, a rubber plate having an image formed therein suitable for transferring an image to an article to be printed, e.g., a web, in a printing process as known in the art. The print cylinder 302 is typically a coated steel cylinder having a smooth surface and a support shaft or arms (not shown) suitable for supporting and rotating the cylinder during processing. The system 304 is similar to the system described above with respect to FIGS. 1 and 2. The system 304 is designed to be robust and to prevent air gaps or delamination at an interface 310 between the print cylinder 302 and the system 304, and interface 308 between the printing plate 306 and the system 304, and between the individual layers of the system 304 (as depicted in FIG. 1).

The system 100 is designed to be robust in printing applications ranging from about one hour to 2-3 weeks or more. The system 100 remains substantially stable and is cleanly and easily removed after use. It is contemplated the system 100 may be used in other applications as well, such as applications requiring clean system removal, improved lamination strength, and/or improved heat and solvent resistance as compared to rubber adhesives, and the like.

Tests were performed on aged samples of conventional rubber-based adhesive tape systems and samples of the adhesive tape system 100. Two samples were taken from five different lots of each of a rubber tape system and the adhesive tape system 100. One sample from each lot of each tape system was heat sealed at 200 degrees Fahrenheit with a 1.5 second dwell. The other sample from each lot of each tape system was conditioned for 24 hours at 158 degrees Fahrenheit. The bond between the respective foam layers and carrier layers were then tested for each of the samples using an Instron T-peel tester at a peel speed of 12 inches per minute.

The results, in pounds per square inch required to peel, or delaminate, the layers of the tape system are shown below in Table 1. As can be seen from the Table 1, in each case, the system 100 had a greater bond between the foam layer are the carrier layer for each sample, regardless of the conditioning method.

TABLE 1

| Tape System | |
|---|---|
| Rubber | System 100 |

| | HEAT | HEAT | HEAT | HEAT |
|---|---|---|---|---|
| Sample # | SEALED | AGED | SEALED | AGED |
| 1 | 1.79 | 2.19 | 2.67 | 2.59 |
| 2 | 1.81 | 2.32 | 2.37 | 2.56 |
| 3 | 2.09 | 2.03 | 2.32 | 2.41 |
| 4 | 2.39 | 1.88 | 3.04 | 2.80 |
| 5 | 1.86 | 2.01 | 3.05 | 2.99 |

Thus, an improved adhesive tape system 100 has been provided. The system 100 advantageously provides improved adhesion between the layers of the system 100. In addition, the system 100 has an improved solvent resistance over conventional rubber-based adhesive tape systems. The system 100 further has a greater heat resistance and is more robust than the conventional rubber-based adhesive tape systems.

While the foregoing is directed to embodiments of the present invention, other and further embodiments of the invention may be devised without departing from the basic scope thereof, and the scope thereof is determined by the claims that follow.

1. An adhesive tape system, comprising:
a carrier layer having a first acrylic-based adhesive disposed on a first side and a second acrylic-based adhesive disposed on an opposing second side; and
a foam layer having a first side bonded to the second side of the carrier layer by the second acrylic-based adhesive and an opposing second side having a third acrylic-based adhesive disposed thereon.

2. The system of claim 1, wherein the first acrylic-based adhesive further comprises:
an acrylic polymer base;
a resin;
a solvent; and
a crosslinker.

3. The system of claim 1, wherein the first acrylic-based adhesive further comprises:
between about 94.60 and about 94.67 percent by weight of an acrylic polymer base;
between about 2.37 to about 2.40 percent by weight of a resin;
between about 2.37 to about 2.40 percent by weight of a solvent; and
between about 0.59 to about 0.60 percent by weight of a crosslinker.

4. The system of claim 1, wherein the first acrylic-based adhesive further comprises:
about 94.641 percent by weight of an acrylic polymer base;
about 2.381 percent by weight of a resin;
about 2.381 percent by weight of a solvent; and
about 0.597 percent by weight of a crosslinker.

5. The system of claim 1, wherein the second acrylic-based adhesive further comprises:
an acrylic polymer base.

6. The system of claim 1, wherein the second acrylic-based adhesive further comprises:
about 100 percent by weight of an acrylic polymer base.

7. The system of claim 1, wherein the third acrylic-based adhesive further comprises:
an acrylic polymer base.

8. The system of claim 1, wherein the second acrylic-based adhesive further comprises:
about 100 percent by weight of an acrylic polymer base.

9. The system of claim 1, wherein the foam layer further comprises:
one of a urethane, polyolefin, vinyl, or polyethylene foam.

10. The system of claim 1, wherein the foam layer further comprises:
an open cell urethane foam.

11. The system of claim 1, wherein the first side and the second side of the foam layer is corona treated.

12. The system of claim 1, wherein the foam layer is between about 20 to about 60 mils thick.

13. The system of claim 1, wherein the carrier layer is fabricated from one of polyethylene terephthalate, polyethylene, polypropylene, polysulfone, polyethersulfone, or polyetherimide.

14. The system of claim 1, wherein the carrier layer is fabricated from polyethylene terephthalate.

15. The system of claim 1, wherein the first side and the second side of the carrier layer is corona treated.

16. The system of claim 1, wherein the carrier layer is between about 0.5 to about 2 mils thick.

17. The system of claim 1, further comprising:
a liner disposed on the first side of the carrier layer.

18. The system of claim 17, wherein the liner comprises at least one of paper, bi-oriented polypropylene, high density polyethylene, polyethylene terephthalate, or polystyrene.

19. The system of claim 17, wherein the liner comprises paper having a coating disposed on both sides of the liner.

20. The system of claim 19, wherein the coating further comprises a polyethylene and silicone coating.

21. An adhesive tape system, comprising:
a carrier layer having a first acrylic-based adhesive disposed on a first side and a second acrylic-based adhesive disposed on an opposing second side;
an open cell urethane foam layer having a first side bonded to the second side of the carrier layer by the second acrylic-based adhesive and an opposing second side having a third acrylic-based adhesive disposed thereon; and
a paper liner disposed on the first side of the carrier layer, the paper liner coated on both sides with a polyethylene and silicone coating.

22. A printing apparatus, comprising:
a printing plate;
a print cylinder; and
an adhesive tape system coupling the printing plate to the print cylinder, the adhesive tape system comprising:
a carrier layer having a first acrylic-based adhesive disposed on a first side and a second acrylic-based adhesive disposed on an opposing second side; and
a foam layer having a first side bonded to the second side of the carrier layer by the second acrylic-based adhesive and an opposing second side having a third acrylic-based adhesive disposed thereon.

23. The apparatus of claim 22, wherein the first acrylic-based adhesive further comprises:
an acrylic polymer base;
a resin;
a solvent; and
a crosslinker.

24. The apparatus of claim 22, wherein the second acrylic-based adhesive further comprises:
an acrylic polymer base.

25. The apparatus of claim 22, wherein the third acrylic-based adhesive further comprises:
an acrylic polymer base.

26. The apparatus of claim 22, wherein the foam layer further comprises:
one of a urethane, polyolefin, vinyl, or polyethylene foam.

27. The apparatus of claim 22, wherein the foam layer further comprises:
an open cell urethane foam.

28. The apparatus of claim 22, wherein the first side and the second side of the foam layer is corona treated.

29. The apparatus of claim 22, wherein the carrier layer is fabricated from one of polyethylene terephthalate, polyethylene, polypropylene, polysulfone, polyethersulfone, or polyetherimide.

30. The apparatus of claim 22, wherein the carrier layer is fabricated from polyethylene terephthalate.

31. The apparatus of claim 22, wherein the first side and the second side of the carrier layer is corona treated.
